(19) United States
(12) Patent Application Publication
(10) Pub. No.: US 2026/0107309 A1
(43) Pub. Date: Apr. 16, 2026

(54) ENHANCED MULTIPLE PRIMARY CHANNEL ACCESS

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US)

(73) Assignee: Ofinno, LLC, Reston, VA (US)

(21) Appl. No.: 19/419,206

(22) Filed: Dec. 15, 2025

Related U.S. Application Data
(63) Continuation of application No. PCT/US2024/034595, filed on Jun. 19, 2024.
(60) Provisional application No. 63/522,223, filed on Jun. 21, 2023.

(51) Int. Cl. H04W 74/0816

(52) U.S. Cl. CPC H04W 74/0816

(57) ABSTRACT

A station (STA) receives a first frame via a first channel and sets a first network allocation vector (NAV) associated with the first channel to a non-zero value based on the first frame. The STA transmits a second frame on a channel comprising the first channel and a second channel, wherein at transmission of the second frame the STA ignores the non-zero value of the first NAV on condition that a second NAV associated with the second channel is zero.

### CROSS-REFERENCE TO RELATED APPLICATIONS

This application is a continuation of International Application No. PCT/US2024/034595, filed June 19, 2024, which claims the benefit of U.S. Provisional Application No. 63/522,223, filed June 21, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example trigger frame.

FIG. 5 illustrates an example multi-user request to send (MU-RTS) trigger frame.

FIG. 6 illustrates an example Common Info field.

FIG. 7 illustrates an example of a Request-to-Send (RTS)/Clear-to-Send (CTS) procedure.

FIG. 8 illustrates an example of a wideband RTS/CTS procedure.

FIG. 9 illustrates an example of a wideband RTS/CTS procedure that uses a bandwidth signaling RTS frame.

FIG. 10 is an example that illustrates an MU-RTS/CTS procedure.

FIG. 11 is an example that illustrates existing multiple primary channel (MPC) STA operation.

FIG. 12 illustrates virtual and physical carrier sense (CS) functions associated with primary and secondary channels for an MPC STA and a non-MPC STA.

FIG. 13 is an example that illustrates a deficiency of an existing MPC STA operation mode.

FIG. 14 is an example that illustrates an MPC STA operation mode according to an embodiment.

FIG. 15 is an example that illustrates another MPC STA operation mode according to an embodiment.

FIG. 16 is another example that illustrates the MPC STA operation mode of FIG. 15.

FIG. 17 is an example that illustrates another MPC STA operation mode according to an embodiment.

FIG. 18 is another example that illustrates the MPC STA operation mode of FIG. 17.

FIG. 19 is an example that illustrates another MPC STA operation mode according to an embodiment.

FIG. 20 is an example that illustrates an AP announcement that may precede use of an MPC STA operation mode according to an embodiment.

FIG. 21 illustrates an example process according to an embodiment.

FIG. 22 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B = {STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

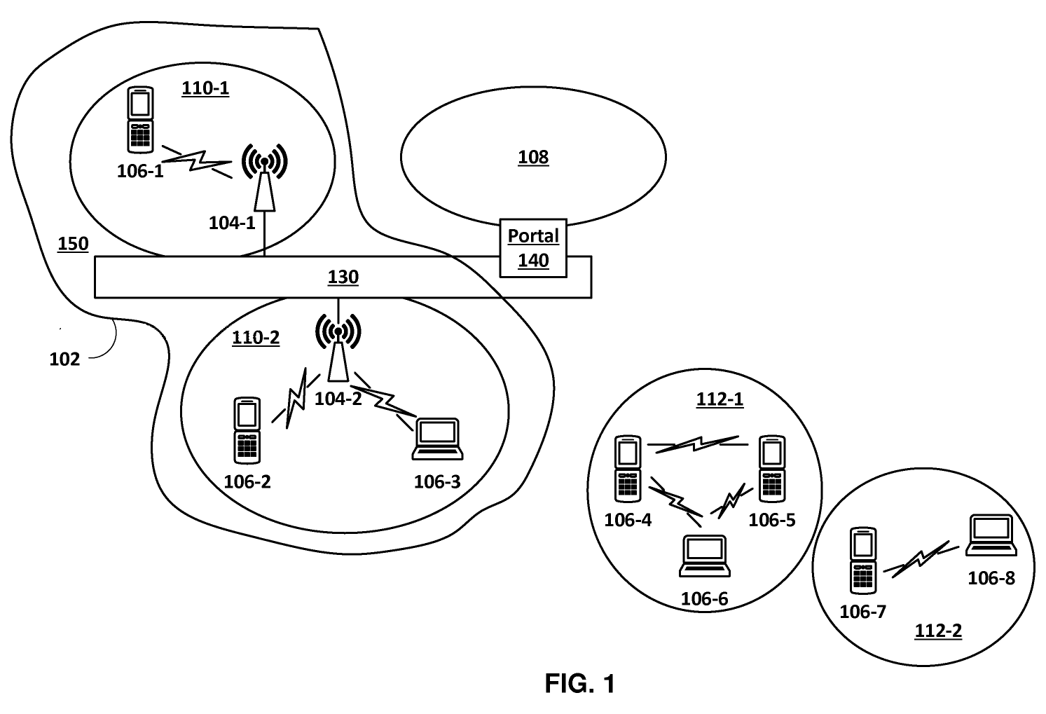

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be optionally formed through channel bonding of a primary 20 MHz channel and one or more 20 MHz secondary channels. For example, PPDUs may be transmitted over physical channels having bandwidths of 40 MHz, 80 MHz, 160 MHz, or 320 MHz by bonding together a primary 20 MHz channel and 1, 3, 7, or 15 secondary channel respectively. The primary channel is a common channel operation for all STAs where management frames are sent by the AP to ensure that all STAs (regardless of channel bonding support) can receive.

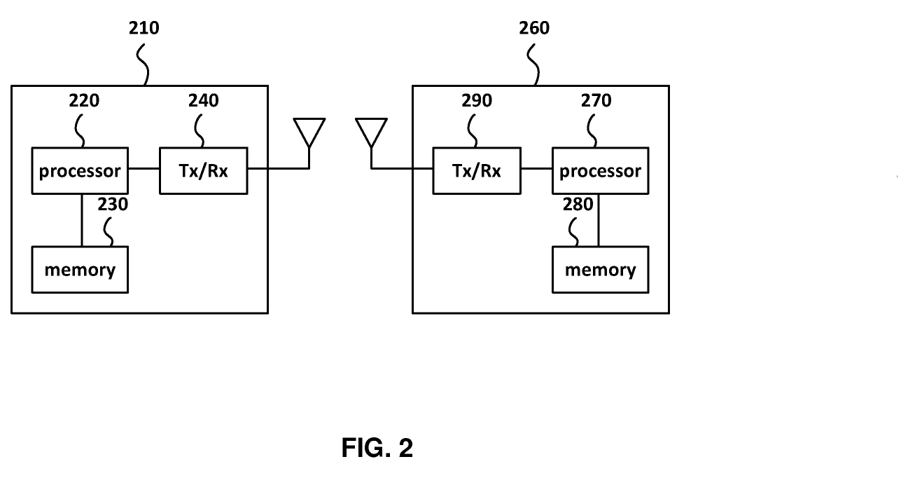

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

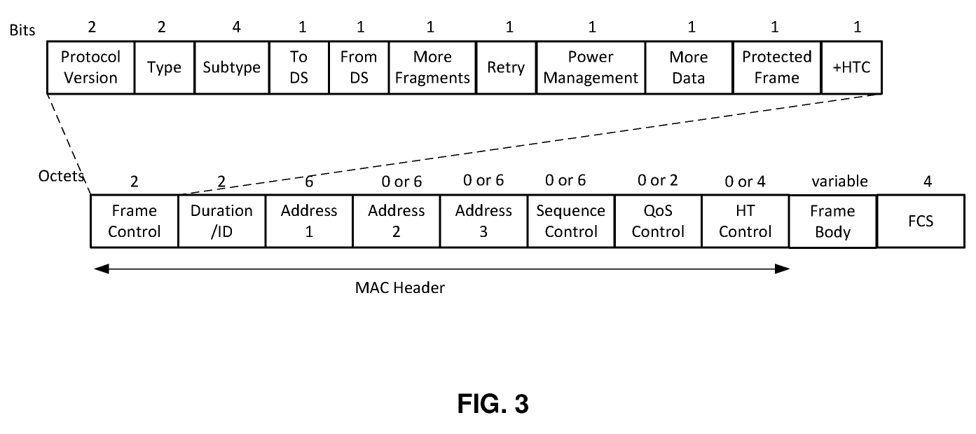

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data , protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1–4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

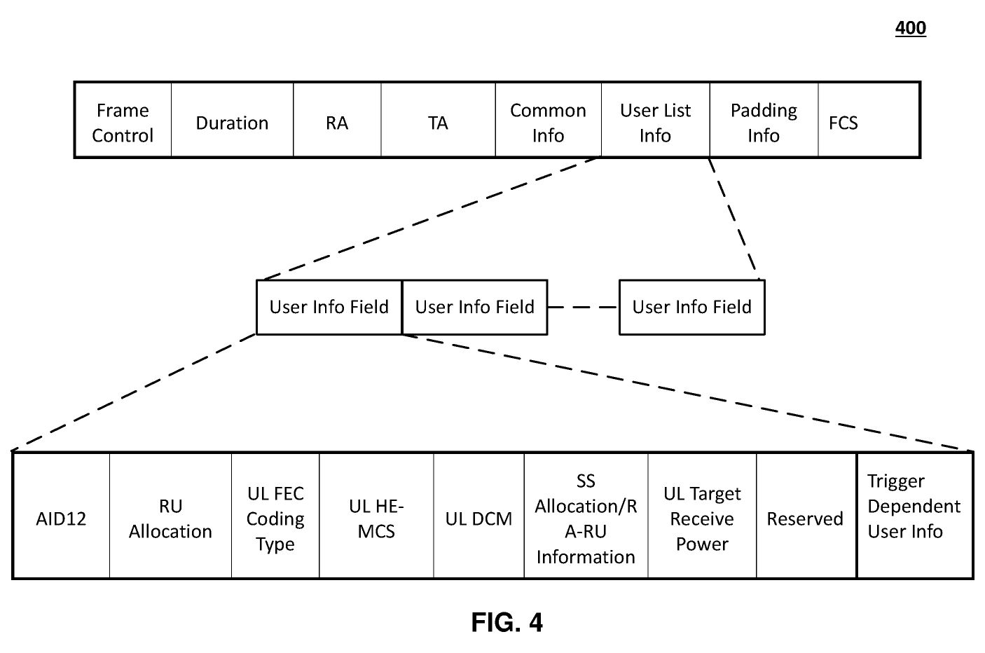

FIG. 4 illustrates an example trigger frame 400. Trigger frame 400 may correspond to a basic trigger frame as defined in the existing IEEE 802.11ax standard amendment. Trigger frame 400 may be used by an AP to allocate resources for and solicit one or more TB PPDU transmissions from one or more STAs. Trigger frame 400 may also carry other information required by a responding STA to transmit a TB PPDU to the AP.

As shown in FIG. 4, trigger frame 400 includes a Frame Control field, a Duration field, a receiver address (RA) field, a transmitter address (TA) field, a Common Info field, a User List Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 400 if trigger frame 400 is addressed to STAs that belong to a single BSS. The TA field is the transmitted BSSID if the trigger frame 400 is addressed to STAs from at least two different BSSs of the multiple BSSID set.

The Common Info field may have a format as illustrated by Common Info field 600 described further below. The Common Info field specifies a trigger frame type of trigger frame 400, a transmit power of trigger frame 400 in dBm, and several key parameters of a TB PPDU that is transmitted by a STA in response to trigger frame 400. The trigger frame type of a trigger frame used by an AP to receive QoS data using UL MU operation is referred to as a basic trigger frame.

The User List Info field contains a User Info field per STA addressed in trigger frame 400. The per STA User Info field includes, among others, an AID subfield, an RU Allocation subfield, a Spatial Stream (SS) Allocation subfield, an MCS subfield to be used by a STA in a TB PPDU transmitted in response to trigger frame 400, and a Trigger Dependent User Info subfield. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 400 to extend the frame length to give recipient STAs enough time to prepare a response for transmission one SIFS (short interframe spacing) after the frame is received. The Padding field, if present, is at least two octets in length and is set to all 1s.

The FCS field is used by a STA to validate a received frame and to interpret certain fields from the MAC headers of a frame.

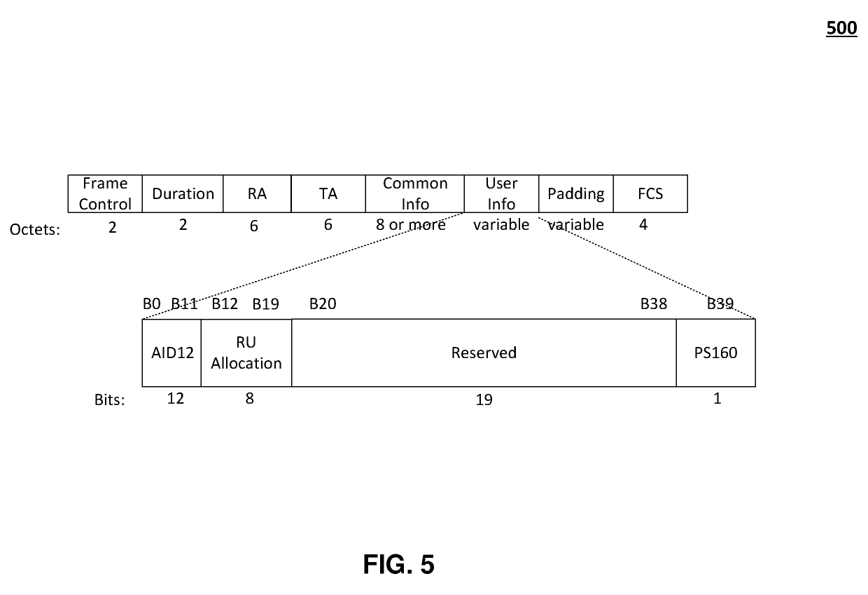

FIG. 5 illustrates an example multi-user request to send (MU-RTS) trigger frame 500. MU-RTS trigger frame 500 may be used by an AP to solicit simultaneous CTS frames from multiple STAs to transmit a downlink (DL) MU PPDU to the multiple STAs. As shown in FIG. 5, MU-RTS trigger frame 500 may comprise a frame control field, a duration field, an RA field, a TA field, a Common Info field, one or more user info fields, a padding field, and an FCS field. The frame control, TA, RA, padding, and FCS fields may be similar to the corresponding fields of trigger frame 400 described above. The Common Info field may have a format as illustrated by Common Info field 600 described further below. The duration field may be set to the time, in microseconds, required to transmit the DL MU PPDU, plus the time required to transmit one CTS frame, one ACK frame (if required), and three SIFS periods.

The one or more user info fields correspond respectively to the one or more STAs solicited by MU-RTS trigger frame 500. As shown in FIG. 5, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

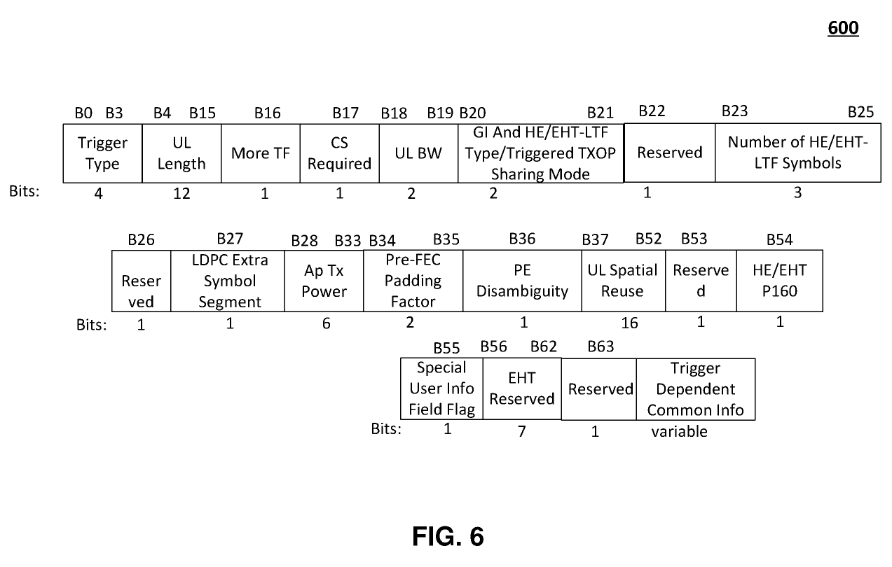

FIG. 6 illustrates an example Common Info field 600. Common Info field 600 may be an embodiment of the Common Info field of trigger frame 400 or MU-RTS trigger frame 500, for example. As shown in FIG. 6, Common Info field 600 may include a Trigger Type subfield, a UL Length subfield, a More TF subfield, a CS required subfield, a UL BW subfield, a GI and HE/EHT-LTF Type/Triggered TXS Mode subfield, a first Reserved subfield, a Number of HE/EHT-LTF Symbols subfield, a second Reserved subfield, an LDPC Extra Symbol Segment subfield, an AP Tx Power subfield, a Pre-FEC Padding Factor subfield, a PE Disambiguity subfield, an UL Spatial Reuse subfield, a third Reserved subfield, an HE/EHT P160 subfield, a Special User Info Field Flag subfield, an EHT Reserved subfield, a fourth Reserved subfield, and a Trigger Dependent Common Info subfield. The Trigger Type subfield, UL Length subfield, More TF subfield, CS required subfield, UL BW subfield, GI and HE-LTF Type/Triggered TXS Mode subfield, first Reserved subfield, Number of HE/EHT-LTF Symbols subfield, second Reserved subfield, LDPC Extra Symbol Segment subfield, AP Tx Power subfield, Pre-FEC Padding Factor subfield, PE Disambiguity subfield, UL Spatial Reuse subfield, third Reserved subfield, HE/EHT P160 subfield, Special User Info Field Flag subfield, EHT Reserved subfield, fourth Reserved subfield, and Trigger Dependent Common Info subfield may have the same content and interpretation as corresponding subfields of an EHT variant Common Info field defined in the IEEE 802.11be draft amendment (“IEEE P802.11be/D3.1, March 2023”).

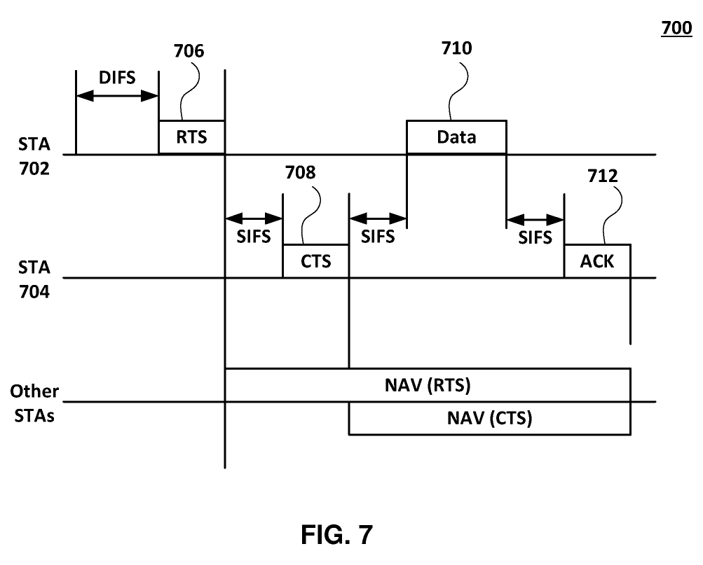

FIG. 7 illustrates an example 700 of a Request-to-Send (RTS)/Clear-to-Send (CTS) procedure. Example 700 may be an example according to the RTS/CTS procedure as defined in section 10.3.2.9 of the IEEE 802.11 standard draft “IEEE P802.11-REVme™/D3.0, April 2023.” As shown in FIG. 7, example 700 may include STAs 702 and 704. Other STAs of the same BSS may also be within communication range of STAs 702 and 704.

In an example, STA 702 may transmit an RTS frame 706 to STA 704. STA 702 may transmit RTS frame 706 to protect from hidden STA(s) the transmission of a data frame 710 that STA 702 intends to transmit. RTS frame 706 may include a Duration/ID field. The Duration/ID field may be set to the time, in microseconds, required to transmit data frame 710, plus one CTS frame, plus one ACK frame (if required), plus three SIFS (Short Interframe Spacing) periods.

In an example, STA 704 may respond to RTS frame 706 by transmitting a CTS frame 708 to STA 702. CTS frame 708 may be transmitted one SIFS period after RTS frame 706. STA 704 may respond to RTS frame 706 when RTS frame 706 is addressed to STA 704 and after considering the NAV, unless the NAV was set by a frame originating from STA 702. STA 704 may respond to the RTS frame 706 when RTS frame 706 is addressed to STA 704 and if the NAV indicates idle. For a non-S1G STA, the NAV indicates idle when the NAV count is 0 or when the NAV count is non-zero but a nonbandwidth signaling TA obtained from a TA field of RTS frame 706 matches a saved TXOP holder address. For an S1G STA, the NAV indicates idle when both the NAV and RID (response indication deferral) counters are 0 or when either the NAV or RID counter is non-zero but the TA field of RTS frame 706 matches the saved TXOP holder address.

STA 704 may set an RA field of CTS frame 708 to a nonbandwidth signaling TA obtained from the TA field of RTS frame 706. STA 704 may set a Duration field of CTS frame 708 based on the Duration/ID field of RTS frame 706, namely as equal to the value of the Duration/ID field of RTS frame 706, adjusted by subtracting the time required to transmit CTS frame 708 and one SIFS period.

Upon receiving CTS frame 708, STA 702 may wait one SIFS period before transmitting data frame 710. STA 704 may transmit an ACK frame 712 in response to data frame 710. STA 704 may transmit ACK frame 712 one SIFS after receiving data frame 710.

As shown in example 700, other STAs within communication range of STAs 702 and 704, and belonging to the same BSS, may set their NAVs according to RTS frame 706 and/or CTS frame 708. For example, a STA receiving RTS frame 706 may set its NAV based on the Duration/ID field of RTS frame 706. Another STA receiving CTS frame 708 may set its NAV based on the Duration field of CTS frame 708. As such, the other STAs may not access the channel using EDCA until the end of transmission of ACK frame 712.

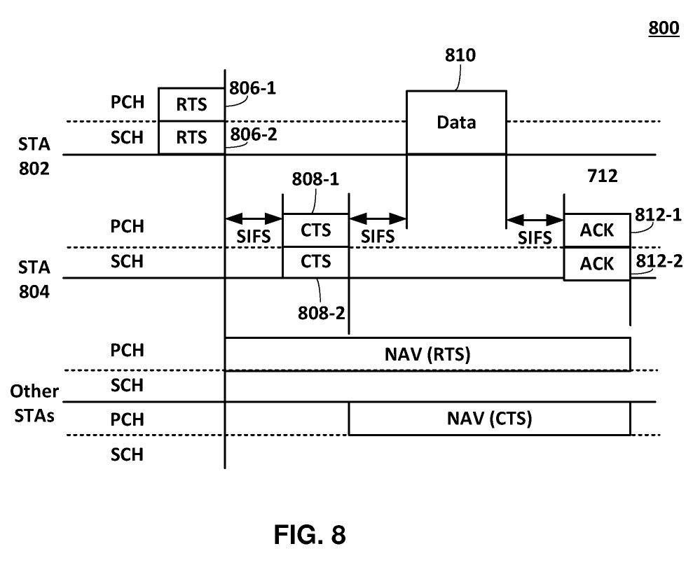

FIG. 8 illustrates an example 800 of a wideband RTS/CTS procedure. As shown in FIG. 8, example 800 may include STAs 802 and 804. Other STAs may also be within communication range of STAs 802 and 804. STAs 802 and 804 may each operate on a primary channel (PCH) and a secondary channel (SCH). For example, without limitation, the PCH may correspond to a primary 20 MHz channel and the SCH may correspond to a secondary 20 MHz channel.

Example 800 may begin with STA 802 accessing both the PCH and SCH to transmit simultaneously RTS frames 806-1 and 806-2 on the PCH and the SCH, respectively, to STA 804. In an example, RTS frames 806-1 and 806-2 may be transmitted in a non-HT duplicate PPDU having a bandwidth equal to the combined bandwidth of the PCH and the SCH (e.g., 40 MHz). In an implementation, before transmitting RTS frames 806-1 and 806-2, STA 802 may check a NAV associated with the PCH. If the NAV associated with the PCH indicates that the PCH is idle, STA 802 may perform a clear channel assessment (CCA) on the PCH and the SCH. The CCA may include determining whether a received signal energy on a channel exceeds an energy detect (ED) threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 802 may access both the PCH and the SCH to transmit RTS frames 806-1 and 806-2.

RTS frames 806-1 and 806-2 may be duplicate frames. RTS frames 806-1 and 806-2 may include a duration field indicating the time, in microseconds, required to transmit a data frame 810, plus one CTS frame, plus one Ack frame, plus three SIFSs.

On receiving RTS frames 806-1 and 806-2, other STAs within the communication range of STA 802 may set a NAV associated with the PCH based on RTS frame 806-1. In an implementation, the other STAs may not maintain a NAV for the SCH.

On receiving RTS frames 806-1 and 806-2, STA 804 responds to STA 802 by transmitting CTS frames 808-1 and 808-2 on the PCH and the SCH respectively. CTS frames 808-1 and 808-2 may be transmitted a SIFS after STA 804 receives RTS frames 806-1 and 806-2 respectively. In an implementation, STA 804 transmits CTS frames 808-1 and 808-2 on the PCH and the SCH respectively based on a NAV associated with the PCH indicating that the PCH is idle. In an implementation, STA 804 may not maintain a NAV for the SCH or may not check a NAV associated with the SCH before transmitting CTS frames 808-1 and 808-2.

On receiving CTS frames 808-1 and 808-2, other STAs within the communication range of STA 804 may set a NAV associated with the PCH based on CTS frame 808-1. In an implementation, the other STAs may not maintain a NAV for the SCH.

On receiving CTS frames 808-1 and 808-2, STA 802 may proceed to transmit data frame 810 on both the PCH and the SCH. Data frame 810 may be transmitted a SIFS after STA 802 receives CTS frames 808-1 and 808-2. In an implementation, STA 802 may proceed to transmit data frame 810 on both the PCH and the SCH on the sole condition of receiving CTS frame 808-1 on the PCH. That is, STA 802 may not be required to receive CTS frame 808-2 on the SCH to transmit data frame 810 on the SCH as well as the PCH.

In an implementation, STA 804 may acknowledge data frame 810 by transmitting ACK frames 812-1 and 812-2 on the PCH and the SCH, respectively. ACK frames 812-1 and 812-2 may be transmitted a SIFS after STA 804 receives data frame 810.

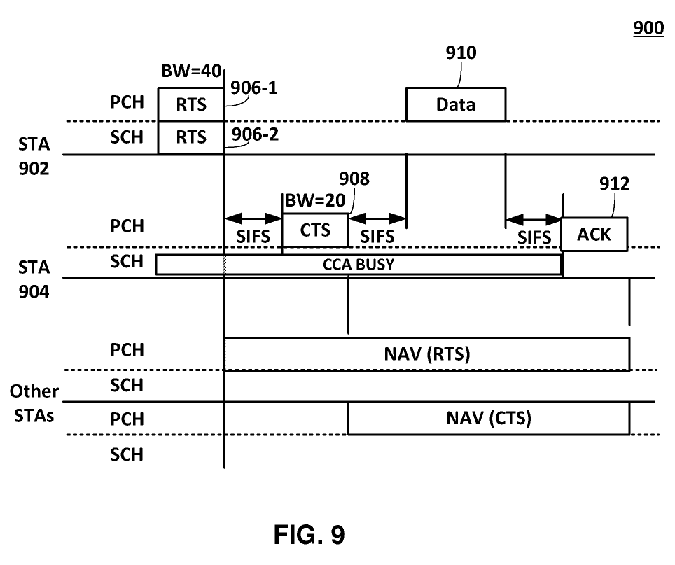

FIG. 9 illustrates an example 900 of a wideband RTS/CTS procedure that uses a bandwidth signaling RTS frame. As shown in FIG. 9, example 900 may include STAs 902 and 904. Other STAs may also be within communication range of STAs 902 and 904. STAs 902 and 904 may each operate on a primary channel (PCH) and a secondary channel (SCH). For example, without limitation, the PCH may correspond to a primary 20 MHz channel and the SCH may correspond to a secondary 20 MHz channel.

Example 900 may begin with STA 902 accessing both the PCH and SCH to transmit simultaneously RTS frames 906-1 and 906-2 on the PCH and the SCH, respectively, to STA 904. In an example, RTS frames 906-1 and 906-2 may be transmitted in a non-HT duplicate PPDU having a bandwidth equal to the combined bandwidth of the PCH and the SCH (e.g., 40 MHz). In an implementation, before transmitting RTS frames 906-1 and 906-2, STA 902 may check a NAV associated with the PCH. If the NAV associated with the PCH indicates that the PCH is idle, STA 902 may perform a CCA on the PCH and the SCH. The CCA may include determining whether a received signal energy on a channel exceeds an ED threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 902 may access both the PCH and the SCH to transmit RTS frames 906-1 and 906-2.

RTS frames 906-1 and 906-2 may be duplicate frames. RTS frames 906-1 and 906-2 may include a duration field indicating the time, in microseconds, required to transmit a data frame 910, plus one CTS frame, plus one Ack frame, plus three SIFSs.

In example 900, RTS frames 906-1 and 906-2 may be bandwidth signaling RTS frames. That is, RTS frames 906-1 and 906-2 may each include a field that indicates the bandwidth of the PPDU (e.g., 40 MHz) carrying RTS frames 906-1 and 906-2.

On receiving RTS frames 906-1 and 906-2, other STAs within the communication range of STA 902 may set a NAV associated with the PCH based on RTS frame 906-1. In an implementation, the other STAs may not maintain a NAV for the SCH.

On receiving RTS frames 906-1 and 906-2, STA 904 may decode the field indicating the bandwidth of the PPDU carrying RTS frames 906-1 and 906-2. The PPDU bandwidth may indicate to STA 904 that STA 902 wishes that STA 904 respond with CTS frames on both the PCH and the SCH. In an implementation, before responding to RTS frames 906-1 and 906-2, STA 904 may check a NAV associated with the PCH. In an implementation, STA 904 may not maintain a NAV for the SCH or may not check a NAV associated with the SCH before responding to RTS frames 906-1 and 906-2. In an implementation, if the NAV associated with the PCH indicates that the PCH is idle, STA 904 may perform a CCA on the PCH and the SCH. In an implementation, STA 904 may respond on both the PCH and the SCH if the CCA indicates “channel idle” on both the PCH and the SCH. In an implementation, STA 904 may respond on the PCH only if the CCA indicates “channel idle” on the PCH and “channel busy” on the SCH. In an implementation, STA 904 may not respond on the PCH or the SCH if the NAV associated with the PCH is non-zero.

In example 900, the CCA returns “channel idle” on the PCH and “channel busy” on the SCH. As such, STA 904 may transmit a CTS frame 908 only on the PCH. CTS frame 908 may thus have a bandwidth that is narrower than the PPDU bandwidth indicated in RTS frames 906-1 and 906-2. CTS frame 908 may be transmitted a SIFS after STA 904 receives RTS frames 906-1 and 906-2 respectively.

On receiving CTS frame 908, other STAs within the communication range of STA 904 may set a NAV associated with the PCH based on CTS frame 908.

On receiving CTS frame 908, STA 902 may proceed to transmit data frame 910 on the PCH. Data frame 910 may be transmitted a SIFS after STA 902 receives CTS frame 908. In an implementation, STA 904 may acknowledge data frame 910 by transmitting an ACK frame 912 on the PCH. ACK frame 912 may be transmitted a SIFS after STA 904 receives data frame 910.

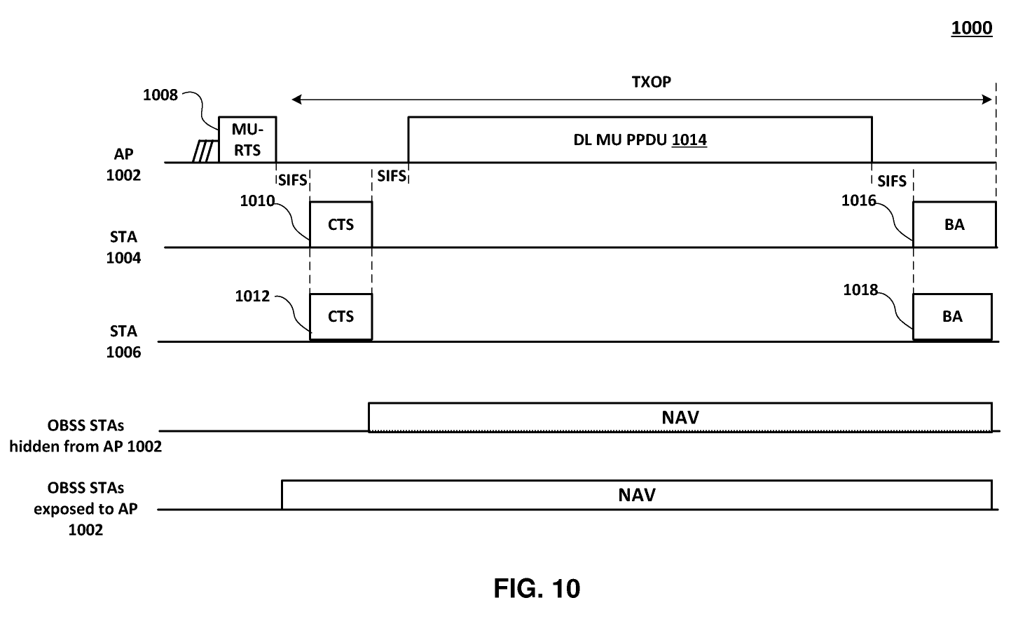

FIG. 10 is an example 1000 that illustrates a multi-user Request-to-Send (MU-RTS)/Clear-to-Send (CTS) procedure. Example 1000 may be an example according to the MU-RTS/CTS procedure as defined in section 26.2.6 of the IEEE 802.11 standard draft (“IEEE P802.11-REVme™/D3.0, April 2023”). As shown in FIG. 10, example 1000 may include an AP 1002 and STAs 1004 and 1006. STAs 1004 and 1006 may be associated with AP 1002. For the purpose of illustration, example 1000 also illustrates STAs of an overlapping basic service set (OBSS) relative to the BSS of AP 1002 (OBSS STAs). The OBSS STAs, as shown in FIG. 10, may be hidden from AP 1002 (outside of the communication range of AP 1002) or exposed to AP 1002 (within the communication range of AP 1002).

In example 1000, AP 1002 wishes to transmit a downlink (DL) multi-user (MU) PPDU 1014 to STAs 1004 and 1006. DL MU PPDU 1014 may comprise data for each of STAs 1004 and 1006. DL MU PPDU 1014 may occupy a plurality of channels (e.g., 20 MHz channels). Each channel of the plurality of channels may carry the data for a respective STA (e.g., STA 1004, STA 1006) served by DL MU PPDU 1014.

As shown in FIG. 10, to protect the transmission of DL MU PPDU 1014 to STAs 1004 and 1006 from interference by OBSS STAs hidden from AP 1002, AP 1002 may use the MU-RTS/CTS procedure to initiate a TXOP and to protect the TXOP frame exchange sequence. AP 1002 may initiate the TXOP by transmitting an MU-RTS trigger frame 1008 that solicits simultaneous CTS frame transmissions from STAs 1004 and 1006.

MU-RTS trigger frame 1008 may have a format as illustrated by MU-RTS trigger frame 500 illustrated in FIG. 5. As such, MU-RTS trigger frame 1008 may comprise a frame control field, a duration field, an RA field, a TA field, a Common Info field, one or more user info fields, a padding field, and an FCS field. The duration field may be set to the time, in microseconds, required to transmit DL MU PPDU 1014, plus the time required to transmit one CTS frame, one ACK frame (if required), and three SIFS periods.

The one or more user info fields correspond respectively to the one or more STAs solicited by the MU-RTS trigger frame. In example 1000, MU-RTS trigger frame 1008 may comprise a user info field for each of STAs 1004 and 1006 indicating that a CTS frame is solicited from each of STAs 1004 and 1006. As shown in FIG. 8, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

AP 1002 may send MU-RTS trigger frame 1008 in a PPDU that occupies one or more channels (e.g., 20 MHz channels). In an example, for each channel occupied by the PPDU that carries MU-RTS trigger frame 1008, AP 1002 may request at least one non-AP STA to send a CTS frame that occupies that channel. In an example, AP 1002 may not request that a non-AP STA send a CTS frame that occupies a channel that is not occupied by the PPDU carrying MU-RTS trigger frame 1008.

After transmitting MU-RTS trigger frame 1008, AP 1002 may wait for a CTSTimeout interval of aSIFSTime + aSlotTime + aRxPHYStartDelay that begins when a MAC layer of AP 1002 receives a PHYTXEND.confirm primitive for transmitted MU-RTS trigger frame 1008. If the MAC layer does not receive a PHY-RXEARLYSIG.indication or a PHY-RXSTART.indication primitive during the CTSTimeout interval, AP 1002 may conclude that the transmission of MU-RTS trigger frame 1008 has failed, and, if MU-RTS trigger frame 1008 initiated a TXOP, AP 1002 may invoke its backoff procedure. If the MAC layer receives a PHY-RXEARLYSIG.indication or a PHY-RXSTART.indication primitive during the CTSTimeout interval, then the MAC layer may wait for the corresponding PHY-RXEND.indication primitive to determine whether transmission of MU-RTS trigger frame 1008 was successful. The receipt of a CTS frame from any non-AP STA addressed by MU-RTS trigger frame 1008 before the PHY-RXEND.indication primitive shall be interpreted as the successful transmission of MU-RTS trigger frame 1008, permitting the frame exchange sequence to continue. The receipt of any other type of frame shall be interpreted as a failure of the transmission of MU-RTS trigger frame 1008. AP 1002 may process the received frame and, if MU-RTS trigger frame 1008 initiated a TXOP, AP 1002 shall invoke its backoff procedure at the PHY-RXEND.indication primitive.

In example 1000, on receiving MU-RTS trigger frame 1008, STAs 1004 and 1006 respond by transmitting respectively CTS frames 1010 and 1012 to AP 1002. In an example, STAs 1004 and 1006 begin the transmission of CTS frames 1010 and 1012, respectively, at the SIFS time boundary after an end of a received PPDU comprising MU-RTS trigger frame 1008. In an example, STA 1004 (or STA 1006) responds to MU-RTS trigger frame 1008 with a CTS frame when the following conditions are met: MU-RTS trigger frame 1008 comprises a user info field addressed to the STA (the AID12 subfield of the user info field is equal to the 12 LSBs of the AID of the STA) and MU-RTS trigger frame 1008 is sent by an AP with which the STA is associated; and the UL MU CS condition indicates that the medium is idle as described in section 26.5.2.5 (UL MU CS mechanism) of the IEEE 802.11 standard (“IEEE P802.11-REVme™/D3.0, April 2023”). Otherwise, if one of the conditions is not met, STA 1004 (or STA 1006) does not send a CTS frame to AP 1002.

In an example, STAs 1004 and 1006 may set an RA field of respectively CTS frames 1010 and 1012 to a TA obtained from the TA field of MU-RTS trigger frame 1008. In an example, STAs 1004 and 1006 may set a duration field of respectively CTS frames 1010 and 1012 based on the duration field of MU-RTS trigger frame 1008, namely as equal to the value of the duration field of MU-RTS trigger frame 1008, adjusted by subtracting the time required to transmit respectively CTS frames 1010 and 1012 and one SIFS period.

OBSS STAs exposed to AP 1002 may receive MU-RTS trigger frame 1008 due to being within the communication range of AP 1002. In an example, as shown in FIG. 10, on receiving MU-RTS trigger frame 1008, OBSS STAs exposed to AP 1002 set their respective NAVs based on the duration field of MU-RTS trigger frame 1008. As such, the OBSS STAs exposed to AP 1002 may not access the wireless medium for the duration of the TXOP initiated by AP 1002.

OBSS STAs hidden from AP 1002 do not receive MU-RTS trigger frame 1008 due to being outside the communication range of AP 1002. However, in an example, as shown in FIG. 10, some of the OBSS STAs hidden from AP 1002 may receive CTS frame 1010 and/or CTS frame 1012 and may set their respective NAVs based on the duration field of CTS frame 1010 and/or CTS frame 1012. As such, some of the OBSS STAs hidden from AP 1002 may also not access the wireless medium for the duration of the TXOP initiated by AP 1002.

On receiving CTS frame 1010 and/or CTS frame 1012, AP 1002 may wait one SIFS period before transmitting DL MU PPDU 1014. On receiving DL MU PPDU 1014, STAs 1004 and 1006 may respond by transmitting respective BlockAck (BA) frames 1016 and 1018 to AP 1002.

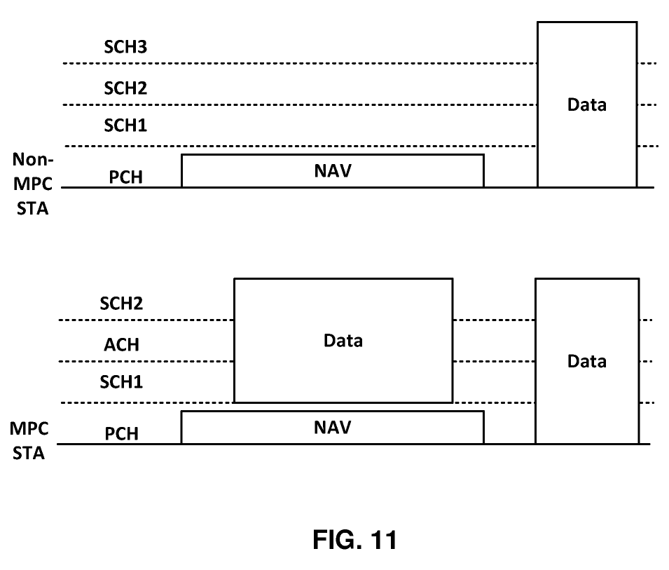

It is envisioned in future IEEE 802.11 standards that a STA may operate with multiple primary channels. Such a STA may be referred to as a multiple primary channel STA (MPC STA). Specifically, in addition to a default primary channel (which is used by all STAs in the BSS), an MPC STA may have one or more secondary channels considered as primary channels. Hereinafter, the default primary channel is referred to as “primary channel” and secondary channel(s) considered as primary channel(s) are referred to as anchor channel(s). The MPC STA may transmit or receive on a channel that includes such anchor channel(s) but that does not necessarily include the primary channel (e.g., when the primary channel is unavailable). An MPC STA may maintain a NAV for an anchor channel independent of the NAV associated with the primary channel. FIG. 11 is an example 1100 that illustrates an existing MPC STA operation mode. For the purpose of illustration, MPC STA operation is contrasted with single primary channel STA (non-MPC STA) operation. As shown in FIG. 11, the non-MPC STA may be capable of operating over a plurality of channels, including a primary channel (PCH), a first secondary channel (SCH1), a second secondary channel (SCH2), and a third secondary channel (SCH2). In an example, the channel corresponding to the second secondary channel (SCH2) of the non-MPC STA may correspond to an anchor channel (ACH) of the MPC STA, and the channel corresponding to the third secondary channel (SCH3) of the non-MPC STA may correspond to a second secondary channel (SCH2) of the MPC STA. The primary channel (PCH) and the first secondary channel (SCH1) of the non-MPC STA and the MPC STA correspond to the same channels. Among these channels, the non-MPC STA supports a single primary channel (i.e., PCH), whereas the MPC STA supports two primary channels (PCH and ACH).

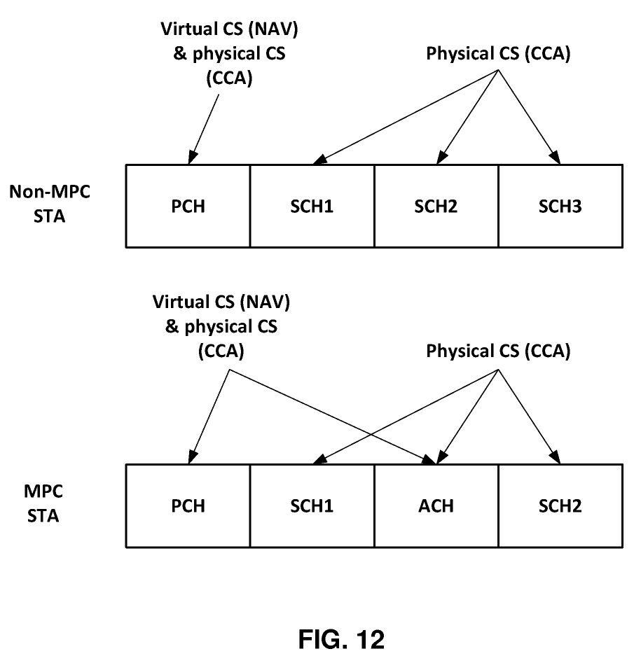

In an implementation, as shown in FIG. 12, in non-MPC STA operation, a virtual carrier sense (CS) function (e.g., NAV) may be associated with only the PCH. Secondary channels may have only a physical CS function (e.g., CCA) associated with them. As such, as shown in FIG. 11, a non-MPC STA may only transmit on a channel that includes the PCH (e.g., PCH, PCH+SCH1, PCH+SCH1+SCH2, PCH+SCH1+SCH2+SCH3) and only when the NAV associated with the PCH is zero (and the CCA indicates “channel idle” for all channels being used).

In contrast, as shown in FIG. 12, in MPC STA operation, a virtual CS function (e.g., NAV) may be associated with multiple channels (e.g., PCH and ACH). As such, as shown in FIG. 11, an MPC STA may transmit on channels that do not include the PCH but that include the ACH (e.g., ACH, ACH+SCH1, ACH+SCH2) if the NAV associated with the ACH is zero (and the CCA indicates “channel idle” for all channels being used). In an implementation, an MPC STA may perform physical and virtual CS functions in parallel on multiple channels (e.g., PCH and ACH). If the PCH is busy (non-zero NAV or CCA indicates “channel busy”), the MPC STA may use the ACH for transmission if the ACH is idle (zero NAV and CCA indicates “channel idle”).

Receiver operations may also differ between a non-MPC STA and an MPC STA. For example, unlike a non-MPC STA which performs preamble/packet detection on the PCH only, an MPC STA may perform parallel preamble/packet detection on multiple channels (e.g., PCH and ACH).

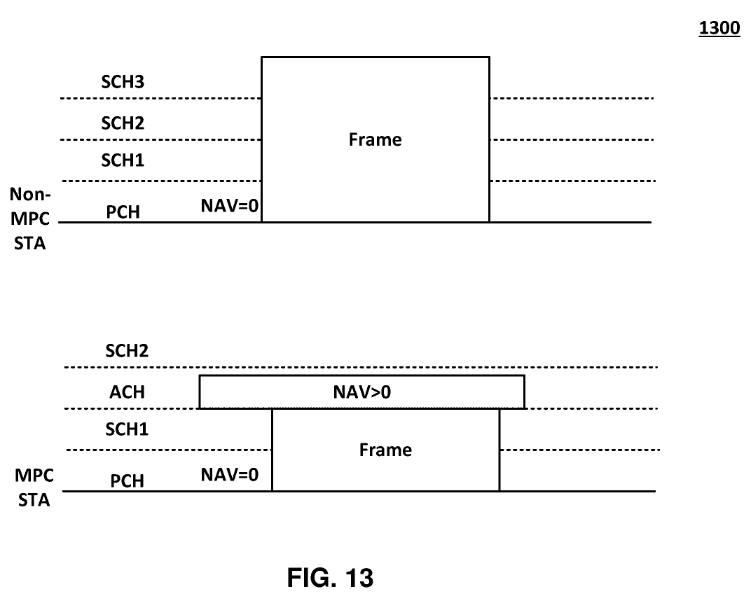

While MPC STA operation is intended to facilitate channel access by a STA, some channel access scenarios may lead to MPC STA operation being inferior to non-MPC STA operation. FIG. 13 illustrates an example 1300 of such scenarios. As shown in FIG. 13, example 1300 includes an MPC STA and a non-MPC STA, where both the MPC STA and the non-APC STA are capable of operating over a plurality of channels covering a certain bandwidth (e.g., 80 MHz). For the non-MPC STA, the plurality of channels comprise a PCH and a plurality of SCHs (SCH1, SCH2, and SCH3). For the MPC STA, the same plurality of channels comprise a PCH, an ACH, and a plurality of SCHs (SCH1 and SCH2). For example, the ACH and SCH2 in MPC STA may correspond to the same channels as SCH2 and SCH3, respectively, in non-MPC STA.

In example 1300, it is assumed that both the MPC STA and the non-MPC STA wish to transmit a frame that covers the entire bandwidth (e.g., 80 MHz). It is further assumed that, at the time of transmission, the PCH is idle (zero NAV and CCA indicates channel idle) but that communication activity over the channel corresponding to SCH2/ACH would cause a NAV for that channel to be non-zero. For the non-MPC STA, as virtual CS (NAV) is not checked for secondary channels, the non-MPC STA is not prevented from communicating over the entire bandwidth by the communication activity over SCH2 (on condition that the physical CS function indicates that SCH2 is idle). As such, the non-MPC STA may transmit a frame over a wideband channel comprising PCH, SCH1, SCH2, and SCH3. In contrast, for the MPC STA, even though the PCH is idle, the non-zero NAV of the ACH prevents the STA from transmitting over a channel comprising the ACH. As such, the STA may only transmit the frame over a narrower channel (e.g., a channel comprising PCH and SCH1).

Embodiments of the present disclosure, as further described below, address the above-described deficiency of the existing MPC STA operation mode. In one aspect, an MPC STA be allowed to ignore a NAV associated with a first channel (e.g., an anchor channel or a second primary channel) when transmitting a frame on a channel comprising the first channel and a second channel (e.g., a primary channel). In an embodiment, the MPC STA may ignore the NAV associated with the first channel on a condition that a NAV associated with the second channel is zero. In another embodiment, the MPC may ignore the NAV associated with the first channel on a further condition that a duration of a PPDU comprising the frame being transmitted is less than a pre-determined PPDU duration. In a further embodiment, the MPC may ignore the NAV associated with the first channel when the frame is of a pre-determined type. Further aspects and details of embodiments of the present disclosure are presented further below.

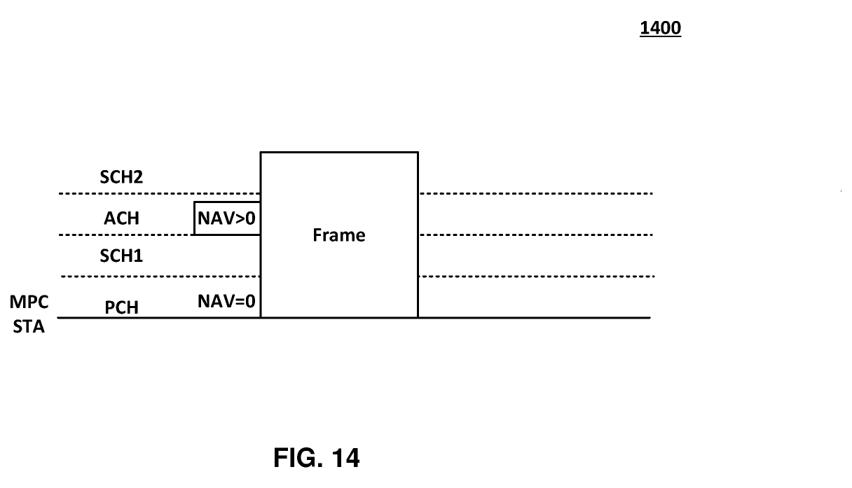

FIG. 14 is an example 1400 that illustrates an MPC STA operation mode according to an embodiment. As shown in FIG. 14, example 1400 includes an MPC STA that is capable of operating over a plurality of channels covering a certain bandwidth (e.g., 80 MHz). The plurality of channels comprise a primary channel (PCH), an anchor channel (ACH), and a plurality of secondary channels (SCH1 and SCH2). In an embodiment, a virtual CS mechanism (e.g., NAV) may be associated with the PCH and the ACH. In an embodiment, a physical CS mechanism (e.g., CCA) may be associated with each of the PCH, ACH, SCH1, and SCH2.

In an embodiment, to transmit a frame over an aggregate channel comprising the PCH and one or more other channels, the MPC STA performs both physical and virtual CS for the PCH. If both the physical and virtual CS indicate that the PCH is idle, the MPC STA may transmit the frame over the aggregate channel on condition that the physical CS returns “channel idle” for the one or more other channels. In an embodiment, where the aggregate channel comprises the ACH, the MPC STA may transmit the frame over the aggregate channel even when the virtual CS associated with the ACH indicates that the ACH is busy (on condition that the physical CS returns “channel idle” for the ACH). That is, when transmitting on an aggregate channel comprising the PCH and the ACH, the MPC STA may ignore the NAV associated with the ACH when the NAV associated with the PCH is zero. For example, as shown in FIG. 14, the MPC STA may transmit the frame over an aggregate channel comprising the PCH in addition to the ACH, SCH1, and SCH2, even when a NAV associated with the ACH is non-zero at the time of the transmission. In an embodiment, the MPC STA may ignore the NAV associated with the ACH as described above when transmitting a frame of pre-determined type, such as an RTS frame or a data frame.

In an embodiment, if the physical or virtual CS indicate that the PCH is busy, the MPC STA may transmit a frame over an aggregate channel comprising the PCH and one or more other channels. In such an embodiment, the MPC STA performs both physical and virtual CS for the ACH. If both the physical and virtual CS indicate that the ACH is idle, the MPC STA may transmit the frame over the aggregate channel on condition that the physical CS returns “channel idle” for the one or more other channels. In an embodiment, where the aggregate channel comprises another channel associated with a NAV (e.g., a second ACH), the MPC STA may transmit the frame over the aggregate channel even when the virtual CS associated with the other channel indicates that the other channel is busy (on condition that the physical CS returns “channel idle” for the other channel).

As would be understood by a person of skill the art based on the teachings herein, in some embodiments, operation as described above in FIG. 14 may not be limited to the ACH and may extend to any other channel associated with a NAV in the MPC STA. Specifically, the MPC STA may ignore the NAV associated with such other channel when the PCH is idle as described above. Conversely, the MPC STA may transmit on an aggregate channel comprising such other channel when the PCH is busy as described above.

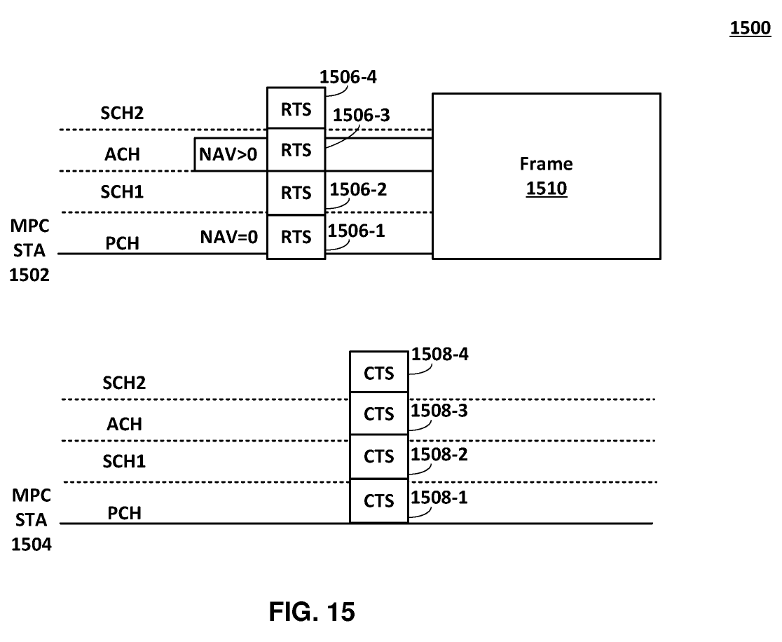

FIG. 15 is an example 1500 that illustrates another MPC STA operation mode according to an embodiment. As shown in FIG. 15, example 1500 includes an MPC STA 1502 and an MPC STA 1504. MPC STA 1502 (or MPC STA 1504) may be an AP STA or a non-AP STA. In an example, MPC STA 1502 may be a non-AP STA and MPC STA 1504 may be an AP STA, or vice versa. MPC STA 1502 may be associated with MPC STA 1504, or vice versa. As MPC STAs, MPC STAs 1502 and 1504 are capable of operating over a plurality of channels covering a certain bandwidth (e.g., 80 MHz). The plurality of channels comprise a primary channel (PCH), an anchor channel (ACH), and a plurality of secondary channels (SCH1 and SCH2). As in example 1400, in an embodiment, a virtual CS mechanism (e.g., NAV) may be associated with the PCH and the ACH in MPC STAs 1502 and 1504. In an embodiment, a physical CS mechanism (e.g., CCA) may be associated with each of the PCH, ACH, SCH1, and SCH2 in MPC STAs 1502 and 1504.

In an embodiment, the MPC STA operation mode of FIG. 15 includes the MPC STA operation mode of FIG. 14 with the further condition of completing an RTS/CTS exchange that results in a CTS frame received via the ACH, prior to using the MPC STA operation mode. For example, in example 1500, MPC STA 1502 wishes to transmit to MPC STA 1504 a frame (e.g., data frame) 1510 over an aggregate channel comprising the PCH, SCH1, ACH, and SCH2. However, as shown in FIG. 15, the NAV associated with the ACH indicates that the ACH is busy. In an embodiment, before proceeding to apply the channel access rules of the MPC STA operation mode illustrated in FIG. 14, MPC STA 1502 transmits to MPC STA 1504 simultaneously RTS frames 1506-1, 1506-2, 1506-3, and 1506-4 on respectively the PCH, SCH1, ACH, and SCH2. In an example, RTS frames 1506-1, 1506-2, 1506-3, and 1506-4 may be transmitted in a non-HT duplicate PPDU having a bandwidth equal to the bandwidth of the aggregate channel (e.g., 80 MHz).

In example 1500, on receiving RTS frames 1506-1, 1506-2, 1506-3, and 1506-4, MPC STA 1504 responds to MPC STA 1502 by transmitting CTS frames 1508-1, 1508-2, 1508-3, and 1508-4 on respectively the PCH, SCH1, ACH, and SCH2. CTS frames 1508-1, 1508-2, 1508-3, and 1508-4 may be transmitted a SIFS after MPC STA 1504 receives RTS frames 1506-1, 1506-2, 1506-3, and 1506-4. In an embodiment, MPC STA 1504 may be configured to respond with a CTS frame on the PCH on condition that a NAV associated with the PCH at MPC STA 1504 is zero (in an embodiment, no physical CS is performed when transmitting a CTS in response to an RTS). Similarly, MPC STA 1504 may be configured to respond with a CTS frame on the ACH on condition that a NAV associated with the ACH at MPC STA 1504 is zero. In an embodiment, MPC STA 1504 may not maintain a NAV for SCH1 and/or SCH2 or may not check a NAV associated with SCH1 and/or SCH2. As such, MPC STA 1504 may respond with CTS frames on SCH1 and SCH2 without regard to a virtual CS for SCH1 and/or SCH2.

On receiving CTS frames 1508-1, 1508-2, 1508-3, and 1508-4 via the PCH, SCH1, ACH, and SCH2 respectively, MPC STA 1502 may determine that it may proceed with the transmission of frame 1510 over the aggregate channel comprising the PCH, SCH1, ACH, and SCH2. Specifically, based on receiving CTS frame 1508-3 via the ACH, MPC STA 1502 determines that the NAV associated with the ACH at MPC STA 1504 is zero. Based on this determination, MPC STA 1502 may determine that transmission over an aggregate channel comprising the ACH is permitted. Specifically, in example 1500, MPC STA 1502 may proceed with transmitting frame 1510 over the aggregate channel comprising the PCH, SCH1, ACH, and SCH2 based on receiving CTS frame 1508-3 and on condition that the NAV associated with the PCH remains zero (as well as the physical CS returning “channel idle” for all channels comprised in the aggregate channel).

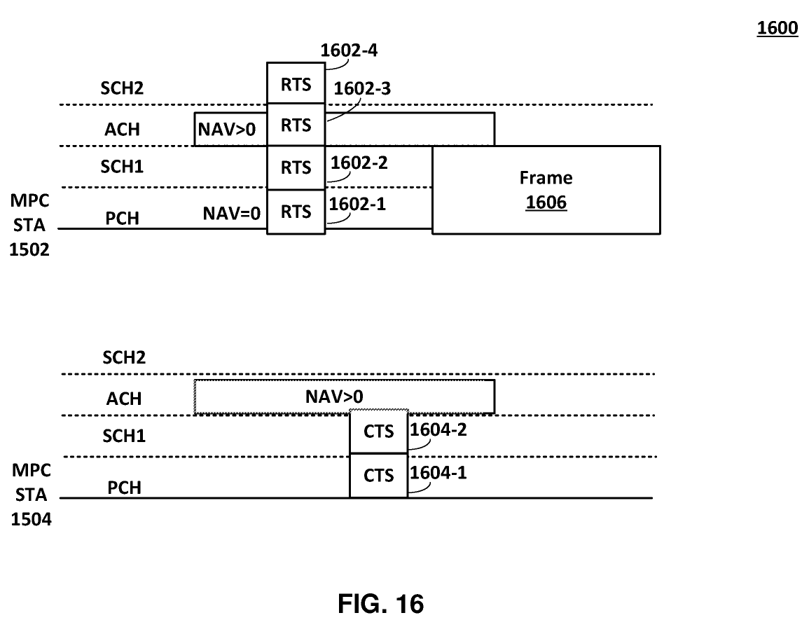

In an embodiment, when the RTS/CTS exchange described in FIG. 15 is not successful and/or does not result in MPC STA 1502 receiving CTS frame 1508-3 via the ACH, MPC STA 1502 may not transmit on an aggregate channel comprising the ACH. FIG. 16 is an example 1600 that illustrates such a scenario according to the MPC STA operation mode of FIG. 15. As shown in FIG. 16, in example 1600, MPC STA 1502 transmits to MPC STA 1504 simultaneously RTS frames 1602-1, 1602-2, 1602-3, and 1602-4 on respectively the PCH, SCH1, ACH, and SCH2. In an example, RTS frames 1602-1,1602-2, 1602-3, and 1602-4 may be transmitted in a non-HT duplicate PPDU having a bandwidth equal to the bandwidth of the aggregate channel (e.g., 80 MHz). On receiving RTS frames 1602-1, 1602-2, 1602-3, and 1602-4, MPC STA 1504 may have the NAV associated with the ACH at a non-zero value. As such, MPC STA 1504 may respond to RTS frames 1602-1, 1602-2, 1602-3, and 1602-4 by transmitting CTS frames 1604-1 and 1604-2 (only) on the PCH and SCH1 respectively. That is, MPC STA 1504 may not transmit a CTS frame on the ACH based on the NAV associated with the ACH having a non-zero value. Similarly, MPC STA 1504 may not transmit a CTS frame on SCH2 based on SCH2 being non-adjacent to the PCH and/or SCH1 (such that an aggregate channel may not be formed of PCH, SCH1, and SCH2).

On receiving CTS frames 1604-1 and 1604-2 via the PCH and SCH1 respectively, MPC STA 1502 determines that it may not proceed with the transmission of a frame over the aggregate channel comprising the PCH, SCH1, ACH, and SCH2. Specifically, based on not receiving a CTS frame via the ACH, MPC STA 1502 may determine that the NAV associated with the ACH at MPC STA 1504 is non-zero. Based on this determination, MPC STA 1502 may determine that transmission over an aggregate channel comprising the ACH is not permitted. In an embodiment, MPC STA 1502 may proceed on transmitting the frame on another aggregate channel that does not comprise the ACH. For example, in example 1600, based on receiving CTS frames 1604-1 and 1604-2 via the PCH and SCH1 respectively, MPC STA 1502 may proceed with transmitting a frame 1606 on an aggregated channel comprising the PCH and SCH1. Frame 1606 may comprise a data frame. As described above, transmission of frame 1606 may be subject to the condition that the NAV associated with the PCH remains zero (as well as the physical CS returning “channel idle” for all channels comprised in the aggregate channel).

As would be understood by a person of skill the art based on the teachings herein, in some embodiments, operation as described above in FIGS. 15 and 16 may not be limited to the ACH and may extend to any other channel associated with a NAV in the MPC STA. Specifically, the MPC STA may ignore the NAV associated with such other channel when the PCH is idle as described above and condition of receiving a CTS frame via such other channel.

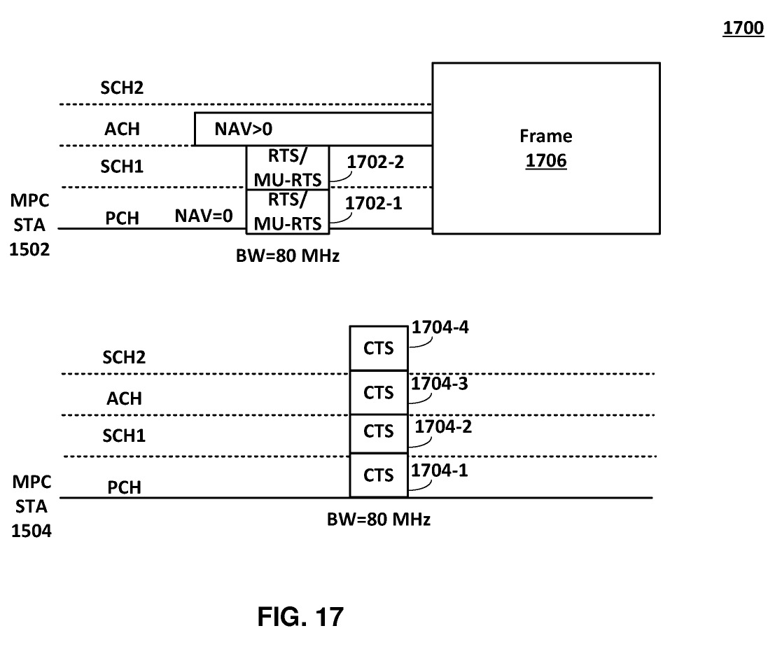

FIG. 17 is an example 1700 that illustrates another MPC STA operation mode according to an embodiment. As in examples 1500 and 1600 described above, example 1700 also includes MPC STAs 1502 and 1504 described above.

In an embodiment, the MPC STA operation mode of FIG. 17 includes the MPC STA operation mode of FIG. 14 with the further condition of completing, prior to using the MPC STA operation mode, an RTS/CTS exchange in which the MPC STA signals a bandwidth comprising the ACH in at least of RTS frame and receives a CTS frame via the ACH. For example, in example 1700, MPC STA 1502 wishes to transmit to MPC STA 1504 a frame (e.g., data frame) 1706 over an aggregate channel comprising the PCH, SCH1, ACH, and SCH2. However, as shown in FIG. 17, the NAV associated with the ACH indicates that the ACH is busy. Unlike the MPC STA operation mode illustrated in FIG. 14, before proceeding to apply the access rules of the MPC STA operation mode, MPC STA 1502 transmits to MPC STA 1504 simultaneously RTS frames 1702-1 and 1702-2 on respectively the PCH and SCH1. In an example, RTS frames 1702-1 and 1702-2 may be transmitted in a non-HT duplicate PPDU having a bandwidth equal to the bandwidth of the combined bandwidth of the PCH and SCH1 (e.g., 40 MHz). In an embodiment, the RTS transmission may not comprise an RTS frame transmitted over the ACH based on the NAV associated with the ACH being non-zero. Similarly, the RTS transmission may not comprise an RTS frame transmitted over SCH2 based on SCH2 being non-adjacent to the PCH and/or SCH1 (such that an aggregate channel may not be formed of PCH, SCH1, and SCH2). In another example, only RTS frame 1702-1 may be transmitted on the PCH.

In an embodiment, RTS frame 1702-1 and/or RTS frame 1702-2 may be a bandwidth signaling RTS frame. That is, RTS frame 1702-1 and/or RTS frame 1702-2 may indicate a bandwidth of the transmission sought to be protected (e.g., frame 1706) by the transmission of RTS frames 1702-1 and 1702-1. In example 1700, the indicated bandwidth may be a bandwidth that comprises the PCH, SCH1, ACH, and SCH2. In another embodiment, RTS frames 1702-1 and 1702-2 may be replaced with respective MU-RTS frames with at least one of the MU-RTS frames indicating the bandwidth of the transmission sought to be protected (e.g., frame 1706) by the transmission of the MU-RTS frames.

In example 1700, on receiving RTS frames 1702-1 and 1702-2, MPC STA 1504 responds to MPC STA 1502 by transmitting CTS frames 1704-1, 1704-2, 1704-3, and 1704-4 on respectively the PCH, SCH1, ACH, and SCH2. CTS frames 1508-1, 1508-2, 1508-3, and 1508-4 may be transmitted a SIFS after MPC STA 1504 receives RTS frames 1702-1 and 1702-2. In an embodiment, MPC STA 1504 determines the bandwidth of the transmission sought to be protected (e.g., frame 1706) from RTS frame 1702-1 and/or RTS frame 1704-2. In example 1700, MPC STA 1504 may determine that the bandwidth comprises the PCH, SCH1, ACH, and SCH2. In an embodiment, MPC STA 1504 may be configured to respond with a CTS frame on the PCH (in response to a bandwidth signaling RTS frame that indicates a bandwidth comprising the PCH) on condition that a NAV associated with the PCH at MPC STA 1504 is zero. Similarly, MPC STA 1504 may be configured to respond with a CTS frame on the ACH (in response to a bandwidth signaling RTS frame that indicates a bandwidth comprising the ACH) on condition that a NAV associated with the ACH at MPC STA 1504 is zero. In an embodiment, MPC STA 1504 may not maintain a NAV for SCH1 and/or SCH2 or may not check a NAV associated with SCH1 and/or SCH2. As such, MPC STA 1504 may respond with CTS frames on SCH1 and SCH2 (in response to a bandwidth signaling RTS frame that indicates a bandwidth comprising SCH1 and SCH2) without regard to a virtual CS for SCH1 and/or SCH2.

On receiving CTS frames 1704-1, 1704-2, 1704-3, and 1704-4 via the PCH, SCH1, ACH, and SCH2 respectively, MPC STA 1502 may determine that it may proceed with the transmission of frame 1706 over the aggregate channel comprising the PCH, SCH1, ACH, and SCH2. Specifically, based on receiving CTS frame 1704-3 via the ACH, MPC STA 1502 determines that the NAV associated with the ACH at MPC STA 1504 is zero. Based on this determination, MPC STA 1502 may determine that transmission over an aggregate channel comprising the ACH is permitted. Specifically, in example 1700, MPC STA 1502 may proceed with transmitting frame 1706 over the aggregate channel comprising the PCH, SCH1, ACH, and SCH2 based on receiving CTS frame 1704-3 and on condition that the NAV associated with the PCH remains zero (as well as the physical CS returning “channel idle” for all channels comprised in the aggregate channel).

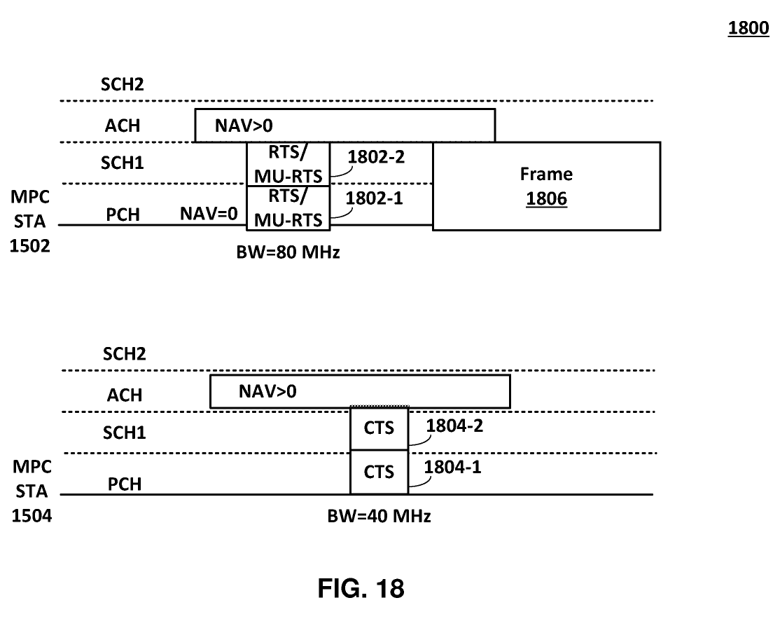

In an embodiment, when the RTS/CTS exchange described in FIG. 17 is not successful and/or does not result in MPC STA 1502 receiving CTS frame 1704-3 via the ACH, MPC STA 1502 may not transmit on an aggregate channel comprising the ACH. FIG. 18 is an example 1800 that illustrates such a scenario according to the MPC STA operation mode of FIG. 17. As shown in FIG. 18, in example 1800, MPC STA 1502 transmits to MPC STA 1504 simultaneously RTS frames 1802-1 and 1802-2 on respectively the PCH and SCH1. In an example, RTS frames 1802-1 and 1802-2 may be transmitted in a non-HT duplicate PPDU having a bandwidth equal to the bandwidth of the combined bandwidth of the PCH and SCH1 (e.g., 40 MHz). In an embodiment, the RTS transmission may not comprise an RTS frame transmitted over the ACH based on the NAV associated with the ACH being non-zero. Similarly, the RTS transmission may not comprise an RTS frame transmitted over SCH2 based on SCH2 being non-adjacent to the PCH and/or SCH1 (such that an aggregate channel may not be formed of PCH, SCH1, and SCH2). In another example, only RTS frame 1702-1 may be transmitted on the PCH.

In an embodiment, RTS frame 1802-1 and/or RTS frame 1802-2 may be a bandwidth signaling RTS frame. That is, RTS frame 1802-1 and/or RTS frame 1802-2 may indicate a bandwidth of the transmission sought to be protected (e.g., a frame 1806) by the transmission of RTS frames 1802-1 and 1802-2. In example 1800, the indicated bandwidth may be a bandwidth that comprises the PCH, SCH1, ACH, and SCH2. In another embodiment, RTS frames 1802-1 and 1802-2 may be replaced with respective MU-RTS frames with at least one of the MU-RTS frames indicating the bandwidth of the transmission sought to be protected (e.g., frame 1806) by the transmission of the MU-RTS frames.

On receiving RTS frames 1802-1 and 1802-2, MPC STA 1504 may have the NAV associated with the ACH at a non-zero value. As such, MPC STA 1504 may respond to RTS frames 1802-1 and 1802-2 by transmitting CTS frames 1804-1 and 1804-2 (only) on the PCH and SCH1 respectively. That is, MPC STA 1504 may not transmit a CTS frame on the ACH based on the NAV associated with the ACH having a non-zero value. Similarly, MPC STA 1504 may not transmit a CTS frame on SCH2 based on SCH2 being non-adjacent to the PCH and/or SCH1 (such that an aggregate channel may not be formed of PCH, SCH1, and SCH2).

On receiving CTS frames 1804-1 and 1804-2 via the PCH and SCH1 respectively, MPC STA 1502 determines that it may not proceed with the transmission of a frame over the aggregate channel comprising the PCH, ACH, SCH1, and SCH2. Specifically, based on not receiving a CTS frame via the ACH, MPC STA 1502 may determine that the NAV associated with the ACH at MPC STA 1504 is non-zero. Based on this determination, MPC STA 1502 may determine that transmission over an aggregate channel comprising the ACH is not permitted. In an embodiment, MPC STA 1502 may proceed on transmitting the frame on another aggregate channel that does not comprise the ACH. For example, in example 1800, based on receiving CTS frames 1804-1 and 1804-2 via the PCH and SCH1 respectively, MPC STA 1502 may proceed with transmitting frame 1806 on an aggregated channel comprising the PCH and SCH1. Frame 1806 may comprise a data frame. As described above, transmission of frame 1806 may be subject to the condition that the NAV associated with the PCH remains zero (as well as the physical CS returning “channel idle” for all channels comprised in the aggregate channel).

As would be understood by a person of skill the art based on the teachings herein, in some embodiments, operation as described above in FIGS. 17 and 18 may not be limited to the ACH and may extend to any other channel associated with a NAV in the MPC STA. Specifically, the MPC STA may ignore the NAV associated with such other channel when the PCH is idle as described above and condition of receiving a CTS frame via such other channel in response to a bandwidth signaling RTS frame or MU-RTS frame.

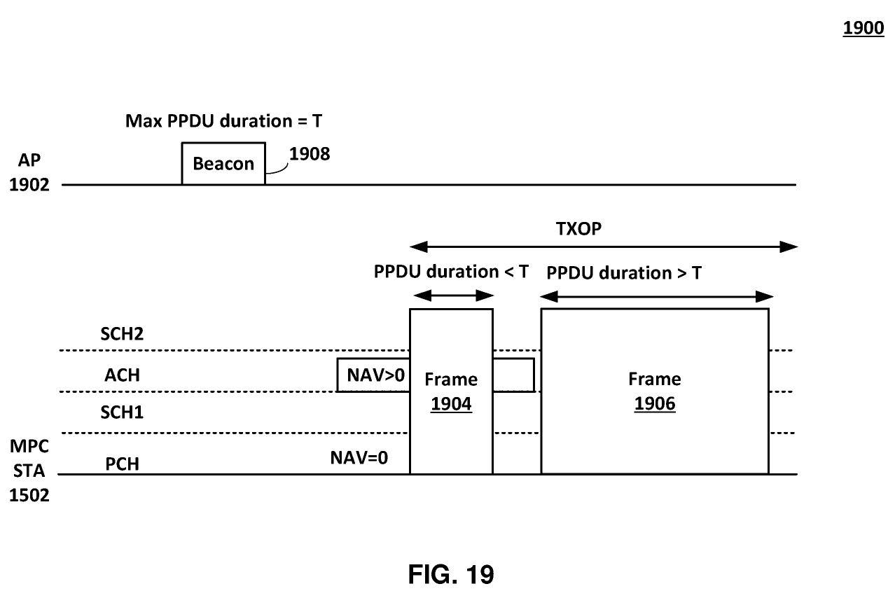

FIG. 19 is an example 1900 that illustrates another MPC STA operation mode according to an embodiment. As in examples 1500, 1600, 1700, and 1800 described above, example 1900 also includes MPC STA 1502 described above. In addition, example 1900 includes an AP 1902 that supports the MPC STA operation mode of FIG. 19. In an example, MPC STA 1502 may be associated with AP 1902.

In an embodiment, the MPC STA operation mode of FIG. 18 includes the MPC STA operation mode of FIG. 14, the MPC STA operation mode of FIGS. 15 and 16, or the MPC STA operation mode of FIGS. 17 and 18 with the further condition that a duration of a PPDU carrying the frame being transmitted (according to the MPC STA operation mode) is below a pre-determined PPDU duration. In an embodiment, the pre-determined PPDU duration may be pre-configured within the MPC STA or signaled to the MPC STA by an AP.

As shown in FIG. 19, example 1900 may begin with AP 1902 transmitting a beacon frame 1908 comprising a maximum duration of a PPDU that may be transmitted according to the MPC STA operation mode. Subsequently, MPC STA 1502 may obtain a TXOP to transmit one or more frames. In an example, based on a duration of a PPDU carrying a first frame 1904 being less than the maximum PPDU duration, MPC STA 1502 may transmit first frame 1904 using the MPC STA operation mode. Specifically, MPC STA 1502 may transmit first frame 1904 on an aggregate channel comprising the PCH, SCH1, ACH, and SH2 despite a NAV associated with the ACH being non-zero. In an example, based on a duration of a PPDU carrying a second frame 1906 being larger than the maximum PPDU duration, MPC STA 1502 may not transmit second frame 1906 using the MPC STA operation mode. Instead, MPC STA 1504 may wait for the NAV associated with the ACH to decrement to zero before transmitting second frame 1506 on the aggregate channel comprising the PCH, SCH1, ACH, and SCH2.

In an embodiment, first frame 1904 may be a short QoS data frame if MPC STA 1502 has a short QoS data frame buffered for AP 1902. In another embodiment, first frame 1904 may be a QoS null frame or an action frame if MPC STA 1502 does not have a short QoS data frame buffered for AP 1902. In another embodiment, first frame 1904 may be a CTS-to-self frame if MPC STA 1502 does not have a short QoS data frame buffered for AP 1902 or if second frame 1906 should be protected by a CTS-to-self frame before transmitting.

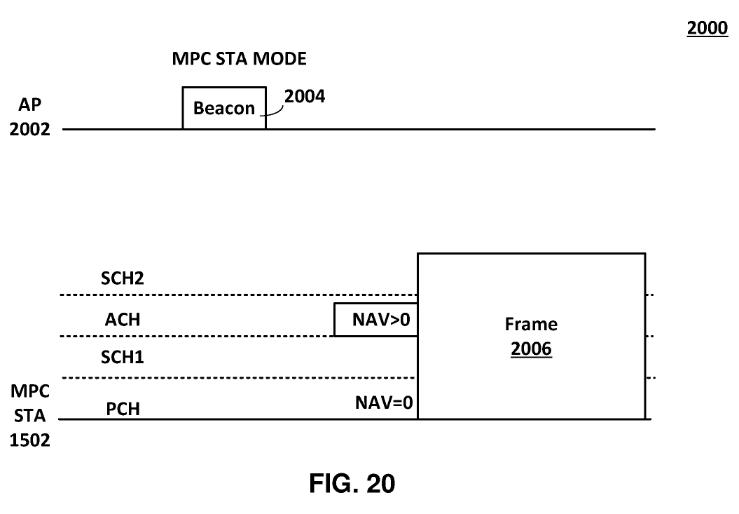

FIG. 20 is an example 2000 that illustrates an AP announcement that may precede use of an MPC STA operation mode according to an embodiment. As shown in FIG. 20, example 2000 also includes MPC STA 1502 described above. In addition, example 2000 includes an AP 2002. AP 2002 may support one or more of the MPC STA operation modes described above. In an example, MPC STA 1502 may be associated with AP 2002.

As shown in FIG. 20, example 2000 may begin with AP 2002 transmitting a beacon frame 2004 indicating an MPC STA operation mode. In example 2000, the indicated MPC STA operation mode may be the MPC STA operation mode of FIG. 14. In an embodiment, AP 2002 indicating an MPC STA operation mode permits (but does not obligate) MPC STA 1502 to use the MPC STA operation mode if supported by MPC STA 1502.

In an embodiment, prior to AP 2002 transmitting beacon frame 2004, AP 2002 and MPC STA 1502 may perform a capability exchange of MPC STA operation modes. During the capability exchange, AP 2002 and MPC STA 1502 may announce their respective supported MPC STA operation modes and may negotiate the MPC STA operation mode to be used. AP 2002 may announce the negotiated MPC STA operation mode in beacon frame 2004. In an embodiment, if the negotiated MPC STA operation mode corresponds to the mode described in FIG. 19, beacon frame 2004 may include a maximum duration of a PPDU that may be transmitted according to the MPC STA operation mode

As would be understood by a person of skill in the art based on the teachings, two or more of the above-described MPC STA operation modes may be readily combined without modification. For example, the MPC STA operation mode of FIG. 19 may be readily combined with the MPC STA operation mode of FIG. 14, the MPC STA operation mode of FIGS. 15 and 16, or the MPC STA operation mode of FIGS. 17 and 18.

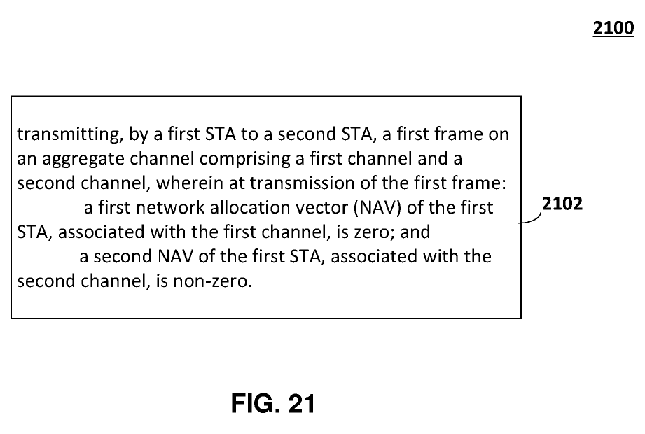

FIG. 21 illustrates an example process 2100 according to an embodiment. Example process 2100 may be performed by a first STA, such as MPC STA 1502, for example. The first STA may be communicating with a second STA. The second STA may be an AP STA or a non-AP STA. The second STA may support MPC STA operation.

As shown in FIG. 21, process 2100 includes, in step 2102, transmitting, by the first STA to the second STA, a first frame on an aggregate channel comprising a first channel and a second channel, where at transmission of the first frame: a first NAV of the first STA, associated with the first channel, is zero; and a second NAV of the first STA, associated with the second channel, is non-zero.

In an embodiment, the first channel is a primary channel of the first STA and the second channel is an anchor channel of the first STA.

In an embodiment, the first channel is an anchor channel of the first STA and the second channel is a secondary channel associated with a NAV.

In an embodiment, process 2100 may further comprise receiving, by the first STA from the second STA, a second frame in response to the first frame. In an embodiment, process 2100 may further comprise transmitting, by the first STA to the second STA, a third frame on the aggregate channel, wherein at transmission of the third frame: the first NAV of the first STA, associated with the first channel, is zero; and the second NAV of the first STA, associated with the second channel is non-zero. In an embodiment, the third frame may comprise a data frame.

In an embodiment, the first frame comprises a data frame, such as frame 1510. In such an embodiment, the second frame may comprise an ACK or BA frame.

In an embodiment, the first frame comprises a CTS-to-self frame. The first frame may then be followed by a data frame after a SIFS duration of transmitting the first frame.

In an embodiment, the first frame comprises an RTS frame or an MU-RTS frame. The RTS frame may be a bandwidth signaling RTS frame. The MU-RTS frame may indicate a bandwidth of the first frame. In such an embodiment, the second frame may comprise a CTS frame. The CTS frame may comprise a CTS frame transmitted on the second channel.

In an embodiment, transmitting the first frame comprises transmitting the first frame on the aggregate channel on condition that a duration of a PPDU comprising the first frame is less than a pre-determined PPDU duration. In an embodiment, process 2100 may further comprise receiving, by the first STA, a management frame indicating the pre-determined PPDU duration. The management frame may be received from the second STA.

In an embodiment, process 2100 may further comprise transmitting, by the first STA to the second STA, a fourth frame on the first channel; and receiving, by the first STA from the second STA, a clear to send (CTS) frame on the second channel. In an embodiment, the fourth frame comprises a bandwidth signaling RTS frame or an MU-RTS frame. The bandwidth signaling RTS frame or the MU-RTS frame signals a bandwidth of the first frame.

In an embodiment, transmitting the fourth frame comprises transmitting the fourth frame prior to transmitting the first frame.

In an embodiment, at transmission of the first frame, a third NAV of the first STA, associated with a third channel, is non-zero. The third channel may be a primary channel or an anchor channel.

In an embodiment, the aggregate channel has a bandwidth of 40 MHz, 80 MHz, 160 MHz, or 320 MHz.

In an embodiment, transmitting the first frame comprises transmitting the first frame on the aggregate channel based on the first frame comprising an RTS frame, a CTS-to-self frame, or an MU-RTS frame.

In an embodiment, process 2100 may further comprise receiving, by the first STA from the second STA, a management frame indicating an operation mode that permits the first STA to ignore the second NAV associated with the second channel.

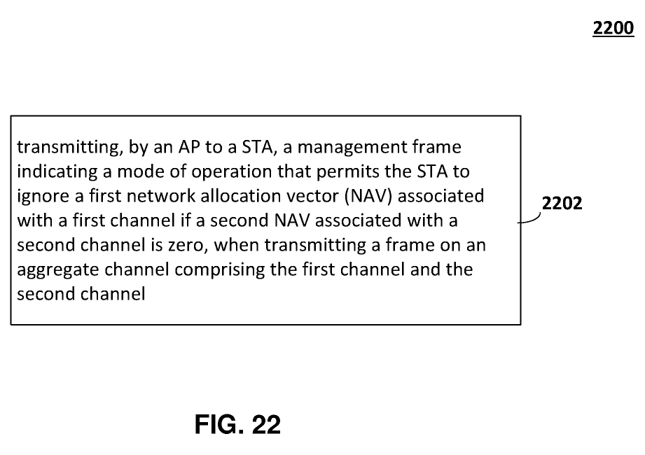

FIG. 22 illustrates another example process 2200 according to an embodiment. Example process 2200 may be performed that support an MPC STA operation mode as described above. As shown in FIG. 22, process 2200 includes, in step 2202, transmitting, by the AP to STA, a management frame indicating an operation that permits the STA to ignore a first NAV associated with a first channel if a second NAV associated with a second channel is zero, when transmitting a frame on an aggregate channel comprising the first channel and the second channel.

In an embodiment, the first channel is a primary channel of the first STA and the second channel is an anchor channel of the first STA. The primary channel may be a primary 20 MHz channel. The anchor channel may be an anchor 20 MHz channel.

In an embodiment, the first channel is an anchor channel of the first STA and the second channel is a secondary channel associated with a NAV.

In an embodiment, process 2200 may further comprise receiving, by the AP from the STA, a frame on the aggregate channel comprising the first channel and the second channel. The frame may be a data frame, an RTS frame, a CTS-to-self frame, or an MU-RTS frame.

In an embodiment, aggregate channel has a bandwidth of 40 MHz, 80 MHz, 160 MHz, or 320 MHz.

In an embodiment, process 2200 may further comprise receiving, by the AP from the STA, a second frame indicating that the STA is capable of receiving a frame from a channel other than the primary channel.

In an embodiment, process 2200 may further comprise transmitting, by the AP to the STA, a third frame indicating that the AP is capable of receiving a frame via a channel other than (or not including) the primary channel.

In an embodiment, the management frame comprises a maximum permitted physical PPDU duration according to the indicated operation mode.

1. A first station (STA) comprising:
one or more processors; and
memory storing instructions that, when executed by the one or more processors, cause the first STA to:
transmit, to a second STA, a first frame on an aggregate channel comprising a first channel and a second channel, wherein at transmission of the first frame:
a first network allocation vector (NAV) of the first STA, associated with the first channel, is zero; and
a second NAV of the first STA, associated with the second channel, is non-zero.

2. The first STA of claim 1, wherein the instructions, when executed by the one or more processors, further cause the first STA to:
receive, from the second STA, a second frame in response to the first frame; and
transmit, to the second STA, a third frame on the aggregate channel, wherein at transmission of the third frame:
the first NAV of the first STA, associated with the first channel, is zero; and
the second NAV of the first STA, associated with the second channel, is non-zero.

3. The first STA of claim 1, wherein the instructions, when executed by the one or more processors, cause the first STA to transmit the first frame on the aggregate channel on condition that a duration of a physical layer protocol data unit (PPDU) comprising the first frame is less than a pre-determined PPDU duration.

4. The first STA of claim 3, wherein the instructions, when executed by the one or more processors, further cause the first STA to receive a management frame indicating the pre-determined PPDU duration.

5. The first STA of claim 1, wherein the instructions, when executed by the one or more processors, further cause the first STA to:
transmit, to the second STA, a second frame on the first channel; and
receive, from the second STA, a clear to send (CTS) frame on the second channel.

6. The first STA of claim 5, wherein the instructions, when executed by the one or more processors, cause the first STA to transmit the second frame prior to transmitting the first frame.

7. The first STA of claim 1, wherein the first channel is a primary channel, and the second channel is an anchor channel.

8. The first STA of claim 1, wherein the second STA comprises an access point (AP).

9. The first STA of claim 8, wherein the instructions, when executed by the one or more processors, further cause the first STA to receive, from the second STA, a management frame indicating an operation mode that permits the first STA to ignore the second NAV.

10. An access point (AP) comprising:
one or more processors; and
memory storing instructions that, when executed by the one or more processors, cause the AP to:
transmit, to a station (STA), a management frame indicating an operation mode that permits the STA to ignore a first network allocation vector (NAV) associated with a first channel if a second NAV associated with a second channel is zero, when transmitting a frame on an aggregate channel comprising the first channel and the second channel.

11. The AP of claim 10, wherein the first channel is a primary channel, and the second channel is an anchor channel.

12. The AP of claim 10, wherein the first channel is an anchor channel, and the second channel is a primary channel.

13. The AP of claim 10, wherein the instructions, when executed by the one or more processors, further cause the AP to receive, from the STA, a frame on the aggregate channel comprising the first channel and the second channel.

14. The AP of claim 10, wherein the instructions, when executed by the one or more processors, further cause the AP to receive, from the STA, a second frame indicating that the STA is capable of receiving a frame via a channel other than a primary channel.

15. The AP of claim 10, wherein the instructions, when executed by the one or more processors, further cause the AP to transmit, to the STA, a third frame indicating that the AP is capable of receiving a frame via a channel other than a primary channel.

16. The AP of claim 10, wherein the management frame comprises a maximum permitted physical protocol data unit (PPDU) duration according to the indicated operation mode.

17. A non-transitory computer-readable medium comprising instructions that, when executed by one or more processors of a first station (STA), cause the first STA to:
transmit, to a second STA, a first frame on an aggregate channel comprising a first channel and a second channel, wherein at transmission of the first frame:
a first network allocation vector (NAV) of the first STA, associated with the first channel, is zero; and
a second NAV of the first STA, associated with the second channel, is non-zero.

18. The non-transitory computer-readable medium of claim 17, wherein the instructions, when executed by the one or more processors, further cause the first STA to:
receive, from the second STA, a second frame in response to the first frame; and
transmit, to the second STA, a third frame on the aggregate channel, wherein at transmission of the third frame:
the first NAV of the first STA, associated with the first channel, is zero; and
the second NAV of the first STA, associated with the second channel, is non-zero.

19. The non-transitory computer-readable medium of claim 17, wherein the first channel is a primary channel, and the second channel is an anchor channel.

20. The non-transitory computer-readable medium of claim 17, wherein the second STA comprises an access point (AP).
